(19) United States
(12) Patent Application Publication
(10) Pub. No.: US 2010/0138338 A1
(43) Pub. Date: Jun. 3, 2010

(54) INTELLIGENT ALERT SYSTEM AND METHOD

(76) Inventors: Ayman Hammad, Pleasanton, CA (US); Mark Carlson, Half Moon Bay, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 12/563,586

(22) Filed: Sep. 21, 2009

Related U.S. Application Data
(60) Provisional application No. 61/173,371, filed on Apr. 28, 2009.
(60) Provisional application No. 61/099,623, filed on Sep. 24, 2008.

(51) Int. Cl. G06Q 40/00; G06F 17/30; G06F 15/16

(52) U.S. Cl. 705/39; 707/705; 709/207; 707/E17.107

(57) ABSTRACT

A system and method for generating an intelligent alert message is disclosed. A user enrolls in the messaging service. Information that the user provides during the enrollment process are sent into a database. the user performs a transaction using a portable consumer device. Transaction data are sent to a computer apparatus. The computer apparatus accesses the database containing alert customization data. An intelligent alert message is generated based on the transaction data and the alert customization data. The intelligent alert message is sent to a user device. For example, after a user uses a portable consumer device to buy gas at a fuel dispenser in a gas purchase transaction, an alert message that is received by a user's phone may be “This is a gas purchase transaction. The amount may vary.” In this example, the amount of the purchase is not known until after the user buys gas.

### CROSS-REFERENCES TO RELATED APPLICATIONS

The present application claims benefit under 35 U.S.C. §119(e) of U.S. Provisional Patent Application No. 61/099,623, entitled “Mobile Alert System and Method,” filed Sep. 24, 2008, and U.S. Provisional Patent Application No. 61/173,371, entitled “Alerts Based System and Method,” filed Apr. 28, 2009, the entire disclosures of which are incorporated herein by reference for all purposes.

### BACKGROUND

There are many occasions where a user may want to be notified when his credit card is being used. For example, a user may want to receive an alert message regarding a recent transaction conducted at a gas station or with an online merchant. The alert message may contain transaction data such as the amount of the transaction, the time the transaction occurred, and the name of the merchant. The alert message may be sent to the user's mobile phone.

The alert message may contain raw transaction data. While this is suitable in some cases, in other cases, the alert message may end up confusing the consumer. For example, when a credit card is used to buy gas at a gas station, an authorization request message is sent to the issuer for $1 in gas purchase transactions to ensure that the card is valid. The amount charged that is actually charged to the user is not known until the user is finished buying the gas. In this case, after the user uses his credit card to interact with a card reader at a fuel dispenser, the user may receive an alert message on his phone indicating that a $1 authorization was requested at the gas station. This alert message will inevitably confuse the user. The user may end up calling the issuer of the credit card asking why a $1 charge was made and further asking why an alert showing the actual amount of the fuel purchase was not received by the user's phone.

Embodiments of the invention address these and other problems, individually and collectively.

### BRIEF SUMMARY

Embodiments of the invention disclosed herein include systems and methods for generating intelligent alert messages. The intelligent alert message system can be implemented using one or more computer apparatus and databases. In embodiments of the invention, transaction data associated with a transaction is received at a computer apparatus. The computer apparatus accesses a database comprising alert customization data. The computer apparatus then generates an intelligent alert message using the transaction data and the alert customization data. The generated intelligent alert message is then sent to a user device.

One embodiment of the invention is directed to a system and method for performing a transaction with a portable consumer device and receiving an intelligent alert message generated by the intelligent alert message system. Another embodiment of the invention is directed to an enrollment process that a user has to go through to subscribe for the messaging service provided by the intelligent alert message system.

Another embodiment of the invention is directed to a system and method for placing dynamic data provided by the issuers in the intelligent alert messages.

As an illustration, after a user uses a portable consumer device to buy gas at a fuel dispenser in a gas purchase transaction, an alert message that is received by a user's phone may be “This is a gas purchase transaction. The amount may vary.” In this example, the amount of the purchase is not known until after the user buys gas. The message is more meaningful to the user than conventional alert messages.

These and other embodiments of the invention are described in further detail below.

### BRIEF DESCRIPTION OF THE DRAWINGS

FIG. 1 shows an intelligent alert messaging system, according to an embodiment of the invention.

FIG. 2 shows a subset of the intelligent alert messaging system, according to an embodiment of the invention.

FIG. 3 shows a flowchart illustrating the steps involved in processing and generating an intelligent alert message, according to an embodiment of the invention.

FIG. 4 shows a system according to an embodiment of the invention.

### DETAILED DESCRIPTION

Embodiments of the invention are directed to a system and method for providing an intelligent alert message to a user when performing a transaction.

In certain embodiments, alert messages may be differ from conventional transaction alert messages in any suitable manner. For example, relative to conventional transaction alert messages, the intelligent alert messages according to embodiments of the invention may be enhanced with additional information and/or may delete non-relevant information. The resulting intelligent alert messages are more meaningful to a consumer. The content of such messages may be dynamic in nature (may vary with each transaction) and may further vary depending on information such as the merchant, the type of transaction (e.g., card not present or card present), the location of the transaction, the characteristics of the user, etc.

In some embodiments, the intelligent alert messages may contain additional information, relative to conventional alert messages. This additional information can reduce user confusion regarding the purpose of the message, as it can be intelligent and meaningful to the consumer. Meaning may be provided by providing the alert message with a better description of the actual transaction that was conducted, omission of confusing or unnecessary information in an alert message, or providing additional information in the alert message that may be more useful for the user or that may help the user better understand the transaction. For example, when a user first checks into a hotel for a two night stay, the user may give the hotel clerk a credit card to charge for any incidental items as well as to charge for the cost of the hotel stay. A conventional transaction notification message such as “Your card 1234 was charged $400” may be sent to the user's phone. The $400 charge may be pre-authorization request to the issuer of the credit card so that the hotel can have an expectation that it will be paid, even though the user's credit card will not be charged $400 at that moment. This may confuse the user, because the user just checked into the hotel. However, in an embodiment of the invention, a more meaningful message could be sent to the user. For example, in an embodiment of the invention, the message may state “Your card 1234 was used to authorize a hotel stay; actual charges will be incurred at a later date.” In some embodiments and in this example, the message may not include certain information (such as pre-authorization values), to reduce user confusion. The messages may also exclude background or processing information that is not particularly useful to the user.

In certain embodiments, the intelligent alert messages may be adjusted based on transaction variables such as country or merchant category. This can allow the message to make sense to the user with limited interpretation or confusion. Some examples of such messaging can include the below examples.

Upon a pre-authorization of a fuel transaction, a transaction notification message can be sent to the user stating “The card 2345 was used for the purchase of fuel.” The message may leave out the pre-authorization value to reduce user confusion. Alternatively, the message may include the pre-authorization value and may note that the actual amount of the transaction may vary (i.e., based on actual fuel dispensed).

In some implementations, a message can be sent upon a pre-authorization of a transit pass. Transit agency use of credit cards (such as at the transit gate or farebox) may not immediately allow for full knowledge of the resulting fare. The final fare associated with a journey on a transit system may not be known until later, after the user exits the transaction system and entry and exit information are processed. Thus, there can be specific message templates for transit agencies such as: “The card [insert card identifier here] was recently used at a transit location.” These messages can leave off the transit amount (which may not be known at that time). In some implementations, the notification server computer or other system may be used to suppress any non-relevant information in the message.

In some implementations, the currency can be shown in the intelligent alert message in both the transacting country currency (merchant country) and the consumer home country (issuer country). In some cases the information on the conversion may be suppressed (i.e., not included in the message). For example, a consumer may receive an intelligent alert message, including all relevant sums, when the consumer is in a foreign country, but pays in the currency of her home country (e.g. when a U.S. resident travels to Canada and pays in U.S. dollars). The intelligent alert message may include the value of the transaction in both Canadian currency and in United States currency.

Other specific examples of embodiments of the invention are described in further detail below.

### I. System

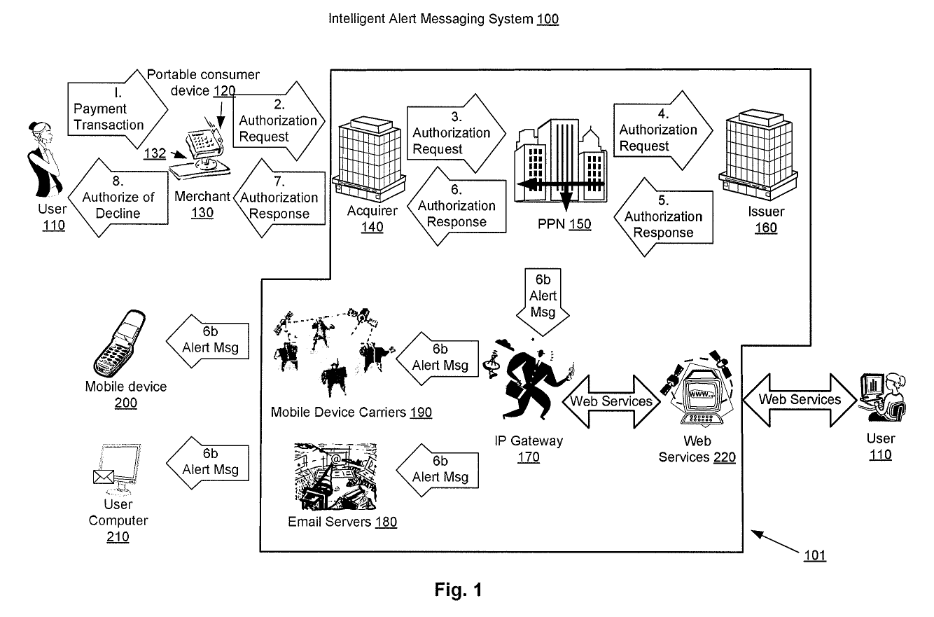

FIG. 1 is a diagram illustrating an intelligent alert messaging system 100, in accordance with an embodiment of the invention. The intelligent alert messaging system 100 includes a user 110, a portable consumer device 120, a merchant 130, an access device 132, an acquirer 140, a payment processing network (PPN) 150, an issuer 160, an IP Gateway 170, mobile device carriers 190, e-mail servers 180, a mobile device 200, a user computer 210, and web services 220. Although one user 110, one mobile device 200, one user computer 210, one merchant 130, one acquirer 140, and one issuer 160 are shown, there may be any suitable number of any of these entities in intelligent alert messaging system 100.

User 110 is in operative communication with the portable consumer device 120. Merchant 130 has an access device 132 for interacting with the consumer portable device 120 and acquirer 140 associated with merchant 130. Acquirer 140 is in communication with issuer 160 through PPN 150.

The intelligent alert messaging system 100 also includes a mobile device 200 in operative communication with user 110 for displaying intelligent alert messages to the user 110.

The intelligent alert messaging system 100 also includes an IP Gateway 170 that is in communication with PPN 150. IP Gateway 170 receives the transaction data from the PPN 150 and generates the intelligent alert messages. IP Gateway 170 is also in communication with the mobile device carriers 190, e-mail servers 180, and web services 220. The mobile device carriers 190 are in operative communication with the mobile device 200, and the mail servers 180 are in operative communication with the user computer 210. The intelligent alert messages that are generated from IP Gateway 170 are sent to the mobile device carriers 190 and/or mail servers 180 to be sent to the mobile device 200, and/or to be accessed by the user computer 210. The web services 220 is also in operative communication with the user 110 for enrolling the user 110 in the messaging service provided by the intelligent alert messaging system 100.

Each of the components shown in FIG. 1 are described in further detail below.

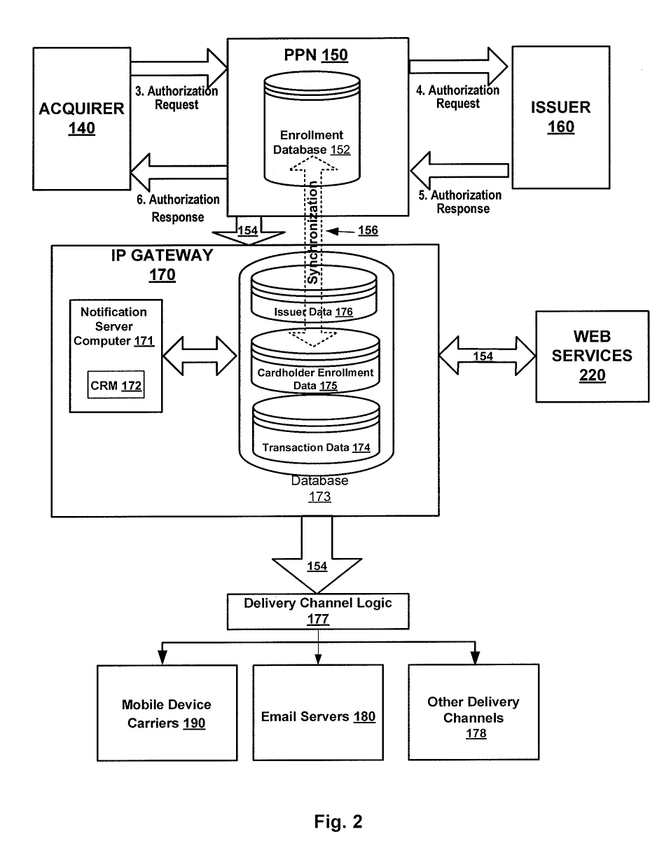

FIG. 2 is a diagram illustrating a subsystem 101 of the intelligent alert messaging system 100. FIG. 2 illustrates more details about the IP Gateway 170. The IP Gateway 170 includes a notification server computer 171 having a computer-readable medium (CRM) 172, and a processor (not shown) that is coupled to the CRM 172. Although one CRM 172 is shown in FIG. 2, the notification server computer 171 may house more than one CRM as needed. The notification server computer 171 is in communication with database 173. In some embodiments, database 173 may be included in the notification server computer 171. Database 173 contains alert customization data that are used to generate the intelligent alert messages. The alert customization data includes transaction data 174, cardholder enrollment data 175, and issuer data 176. Cardholder enrollment data 175 are synchronized with the enrollment database 152 via the synchronization link 156. The enrolment database 152 contains data related to users who are enrolled in the messaging service. As shown in FIG. 2, IP Gateway 170 is in communication with PPN 150, and web services 220 via the network connection 154 which may be in any suitable form. The network connection 154 may include, for example, at least a portion of the Internet. Delivery channel logic 177 is in communication with IP Gateway 170, mobile service carriers 190, e-mail servers 180, and other delivery channels 178.

User 110 refers to an individual or organization such as a business that is capable of purchasing goods or services or making any suitable transaction with merchant 130.

Portable consumer device 120 refers to any suitable device that allows the transaction to be conducted with merchant 130. Portable consumer device 120 may be in any suitable form. For example, suitable portable consumer devices 120 can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices 120 include cellular phones, personal digital assistants (PDAs), pagers, payment cards, security cards, access cards, smart media, transponders, and the like. In some cases, portable consumer device 120 may be associated with an account of user 110 such as a bank account.

Merchant 130 refers to any suitable entity or entities that make a transaction with user 110. Merchant 130 may use any suitable method to make the transaction. For example, merchant 130 may use an e-commerce business to allow the transaction to be conducted by merchant 130 through the Internet. Other examples of merchant 130 include a department store, a gas station, a drug store, a grocery store, or other suitable business.

Access device 132 may be any suitable device for communicating with merchant 130 and for interacting with portable consumer device 120. Access device 132 can be in any suitable location such as at the same location as merchant 130. Access device 132 may be in any suitable form. Some examples of access devices 132 include POS devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, websites, and the like. Access device 132 may use any suitable contact or contactless mode of operation to send or receive data from portable consumer devices 120.

If access device 132 is a POS terminal, any suitable POS terminal may be used and may include a reader, a processor, and a computer-readable medium. Reader may include any suitable contact or contactless mode of operation. For example, exemplary card readers can include radio frequency (RF) antennas, optical scanners, bar code readers, magnetic stripe readers, etc. to interact with portable consumer device 120.

Acquirer 140 refers to any suitable entity that has an account with merchant 130. In some embodiments, issuer 160 may also be acquirer 140.

Payment processing network (PPN) 150 refers to a network of suitable entities that have information related to an account associated with portable consumer device 120. This information includes data associated with the account on portable consumer device 120 such as profile information, data, and other suitable information.

PPN 150 may have or operate a server computer and may include a database. The database may include any hardware, software, firmware, or combination of the preceding for storing and facilitating retrieval of information. Also, the database may use any of a variety of data structures, arrangements, and compilations to store and facilitate retrieval of information. The server computer may be coupled to the database and may include any hardware, software, other logic, or combination of the preceding for servicing the requests from one or more client computers. Server computer may use any of a variety of computing structures, arrangements, and compilations for servicing the requests from one or more client computers.

PPN 150 may include data processing subsystems, networks, and operations used to support and deliver authorization services, exception file services, and clearing and settlement services. An exemplary PPN 150 may include VisaNet™. Networks that include VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. PPN 150 may use any suitable wired or wireless network, including the Internet.

Issuer 160 refers to any suitable entity that may open and maintain an account associated with portable consumer device 120 for user 110. Some examples of issuers may be a bank, a business entity such as a retail store, or a governmental entity. In many cases, issuer 160 may also issue portable consumer device 120 associated with the account to user 110.

IP Gateway 170 refers to an entity that generates and delivers notifications and intelligent alert messages to various delivery channels. IP gateway may include one or more servers and databases for generation of the intelligent alert messages and retrieval of data. IP Gateway 170 may be part of the PPN 150 or may be a separate entity in communication with PPN 150.

Notification server computer 171 may be a powerful computer or cluster of computers. For example, the server computer can be a large mainframe, a minicomputer cluster, or a group of servers functioning as a unit. In one example, the notification server computer may be a database server coupled to a Web server. Notification server computer 171 includes a computer-readable medium (CRM) 172 and a processor (not shown) coupled to the CRM 172.

Database 173 may be in the form of one or more server computers for storage of data. It may also be in the form of one or more electronic storage units (stand alone hard drives) capable of storing electronic data.

Delivery channel logic 177 may be in the form of an application program that sends the intelligent alert messages to the appropriate delivery channel. Delivery channel logic 177 may be part of the IP gateway 170 or the PPN 150. In some embodiments, delivery channel logic runs on a server computer that is in communication with the notification server computer 171. In other embodiments, delivery channel logic may run on the notification server computer 171.

E-mail servers 180 are server computers configured to receive an e-mail from a network connection and store the e-mail in memory for future retrieval.

Mobile device carriers 190 refer to entities that provide wireless infrastructures for wireless data transfer and communication via cellular phone or other mobile devices. Example of such entities are AT&T™, Verizon Wireless™, T-Mobile™, etc.

Mobile device 200 may be in any suitable form. For example, suitable mobile device 200 can be hand-held and compact so that they can fit into a consumer's wallet and/or pocket (e.g., pocket-sized). Some examples of mobile device 200 include desktop or laptop computers, cellular phones, personal digital assistants (PDAs), pagers, payment cards, security cards, access cards, smart media, transponders, and the like. In some embodiments, mobile device 200 and portable consumer device 120 are embodied in the same device.

User computer 210 may be a personal computer or a laptop. The User computer 210 may run an operating system such as Microsoft Windows™ and may have a suitable browser such as Internet Explorer™.

Web services 220 may be in the form of a server and a website which allows users to enroll in the messaging service. Web services 220 may be provided by the issuer 160 or the PPN 150.

### II. Method

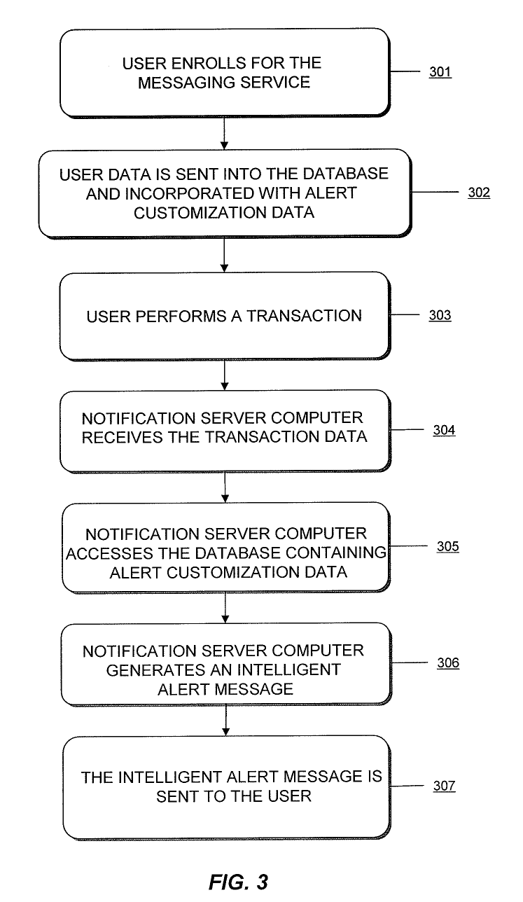

FIG. 3 is a flowchart that illustrates the entire process from enrollment of a user for the messaging service until delivery of the intelligent alert messages. As shown in FIG. 3, the user 110 first has to enroll in the messaging service (step 301). The user data that the user 110 provides during the enrollment process are then sent into the database 173 and incorporated with the alert customization data (step 302). The user 110 then performs a transaction using the consumer portable device 120 (step 303). Next, the IP Gateway 170 receives the transaction data 174 from the PPN 150 (step 304). After receiving the transaction data 174, the notification server computer 171 in the IP Gateway 170 accesses the database 173 that contains the alert customization data (step 305). The notification server computer 171 then generates an intelligent alert message (step 306). Finally, the intelligent alert message is delivered to the user 110 (step 307). Each of these steps will now be described in detail with reference to FIG. 1 and FIG. 2.

### A. Enrollment

In order to receive the intelligent alert messages associated with a transaction, user 110 must be enrolled for the messaging service provided by the intelligent alert messaging system 100. This is shown as step 301 in FIG. 3. There may be multiple ways in which the user 110 may become enrolled in the messaging service. In some embodiments, the user 110 may be enrolled automatically by the issuer 160 that issues the portable consumer device 120. Enrollment may also be done in a batch mode, by file delivery from issuer 160 or by file delivery from some other party. In other embodiments, the issuer 160 or PPN 150 may provide the messaging service as an option to the user 110 at which time the user 110 may enroll in the messaging service either by contacting a customer service representative over the phone (provided either by the issuer 160 or PPN 150), or by accessing a web site and filling out an online application. In certain implementations, the web site may be hosted by one entity but can redirect the consumer to a site hosted by another entity.

During the enrollment process either by accessing a web site and filling an online application or by contacting a customer service, the user 110 provides some information that will be used by the intelligent alert messaging system 100 for generation and delivery of the intelligent alert messages. The user 110 may access the web site or contact the issuer 160 to change the information provided at any time.

User 110 may provide information regarding his mobile device 200 such as make and model number and the entity that is the carrier for wireless service of that mobile device 200. In one embodiment, user 110 may only provide a phone number associated with the mobile device 200, and the issuer 160 or PPN 150 will determine the entity that provides wireless service for that mobile device 200. In addition to the information regarding the mobile device 200, the user 110 may set some preferences regarding the language and preferred delivery channels of the intelligent alert message. For example, user 110 may specify during the enrollment process that he would like to receive the intelligent alert messages in a particular language. User 110 may also specify that he would like to receive the intelligent alert messages in the form of text messages on his mobile device 200, and in the form of e-mail at a particular e-mail address. In some embodiments, the user 110 may specify other preferences that will govern the generation and delivery of the intelligent alert messages. For example, user 110 may specify that he would like to receive the intelligent alert messages for purchases over a specific amount.

The information that the user 110 provides is stored in the database 173 in the form of cardholder enrollment data 175, also referred to as the user data. This is shown as step 302 in FIG. 3. These data, in addition to the transaction data 174 and issuer data 176, can be referred to as alert customization data which is used by the notification server computer 171 to generate the intelligent alert messages. It is noted that other data from other sources may also be used to customize alert messages.

### B. Performing a Transaction

FIG. 1 illustrates a process involved in performing a transaction according to an embodiment of the invention. This is shown as step 303 in FIG. 3. In a typical purchase transaction, the user 110 purchases goods or services at the merchant 130 using the portable consumer device 120 (arrow 1 in FIG. 1). An authorization request message comprising transaction data is generated by a processor in the access device 132 after the portable consumer device 120 interacts with the access device 132. The authorization request message may comprise, for example, the BIN (bank identification number) and expiration date associated with the portable consumer device 120, the purchase amount, and a merchant code such as a merchant category code (MCC). The authorization request message is then forwarded from the merchant 130 to the acquirer 140 (arrow 2 in FIG. 1). After receiving the authorization request message, it is then sent to the PPN 150 (arrow 3 in FIG. 1).

The PPN 150 then forwards the authorization request message to the issuer 160 of the portable consumer device 120 (arrow 4 in FIG. 1). After the issuer 160 receives the authorization request message, the issuer 160 sends an authorization response message back to the PPN 150 to indicate whether or not the current transaction is authorized (or not authorized) (arrow 5 in FIG. 1).

After the PPN 150 receives the authorization response message, it then forwards the authorization response message back to the acquirer 140 (arrow 6 in FIG. 1). The acquirer 140 then sends the response message back to the merchant 130 (arrow 7 in FIG. 1), and it is then presented to the user 110 (arrow 8 in FIG. 1).

If the user 110 is enrolled in the messaging service, the PPN 150 sends the transaction data to the IP Gateway 170 (arrow 6b in FIG. 1). In order for the PPN 150 to determine whether the authorization request is associated with a portable consumer device 120 that is enrolled in the messaging service, the PPN 150 maintains a list of account numbers associated with users who are enrolled in the messaging service in the enrollment database 152. The data in the enrollment database 152 are synchronized with the appropriate portion(s) of the cardholder enrollment data 175 via synchronization link 156 which may be in any suitable form. For example, the synchronization link 156 may be in the form of local area network connection or Internet.

After the PPN 150 receives an authorization response from the issuer 160, an application program, running on a computer (not shown) in PPN 150, compares the account number associated with the authorization request (or the authorization response) with a list of enrolled account numbers in the enrollment database 152. If there is a match, which indicates that the account number associated with portable consumer device 120 is enrolled in the messaging service, the PPN 150 sends the transaction data 174 associated with that particular transaction to the IP Gateway 170.

### C. Generating an Intelligent Alert Message

After the IP gateway 170 receives the transaction data 174 from the PPN 150 (step 304), the notification server computer 171 begins the process of constructing an intelligent alert message for that transaction. During this process, regular processing for transaction authorization continues as normal with the issuer, while at the same time the transaction is inspected and compared to pre-established selected triggers and preferences. The intelligent alert messages are generated and delivered in real time or near real time to the user 110. Many times the intelligent alert message is received before the user 110 leaves a checkout counter at the merchant 130.

In one embodiment, IP gateway 170 may be part of the PPN 150. In other embodiments, IP gateway 170 may be a third party entity in communication with PPN 150 that receives the transaction data 174 and generates the alert messages. In other embodiments, after the transaction data 174 is received from the PPN 150, the notification server computer 171 begins the process of generating an intelligent alert message for that transaction. In one embodiment, the transaction data (174) may be stored in database 173 which is then accessed by the notification server computer 171, along with cardholder enrollment data 175 and/or issuer data 176, to generate an intelligent alert message. In other embodiments, the transaction data 174 may be sent directly to the notification server computer 171.

The transaction data 174 received from the PPN 150 contains information such as an account number associated with the portable consumer device 120, name of the merchant 130 (or other merchant identifier such as a merchant category code or MCC) and the amount of the transaction. The transaction data 174 may also contain other information such as the location of the merchant 130. In some embodiments, the transaction data may not contain all of the information needed to identify some aspect of the transaction such as the location of the merchant 130. However, the transaction data contains processing codes and reference numbers that may be used to acquire further needed information regarding a transaction.

Depending on the complexity and the information that an intelligent alert message may contain, the transaction data 174 are analyzed by the notification server computer 171 and used to generate an intelligent alert message that can be easily understood by the user 110. To begin this process, the notification server computer 171 accesses the database 173 that contains the alert customization data (step 305). Depending on the cardholder enrollment data 175 that the user 110 has provided during the enrolment process regarding his preference of delivery channels, type of mobile device 200, and other formatting preferences, the notification server computer 171 generates an intelligent alert message that meets the preferences of the user 110, and conforms with the technical requirements regarding the multiple delivery channels.

The intelligent alert message can be generated using rules that generate certain messages and message formats depending upon the values of certain data elements in the transaction data 174. Such data elements can include: the merchant identifier (e.g., the MCC), the amount of the transaction, and the location of the transaction. In the case of the merchant identifier, different classes of messages may be generated based on the data indicating the type of merchant or data identifying the specific merchant. For example, transaction data that indicates that a transaction is being conducted at a fuel dispenser (e.g., a gas station) may always have the message “amount may vary” when the corresponding authorization request message is only being sent in order to validate the card being used to make the purchase. In a gas purchase transaction, the amount of the purchase is not known at the time that the fuel dispenser receives user data from the user's portable consumer device (e.g., credit card). In comparison, transaction data that indicates that a transaction is being conducted at a department store may send an intelligent alert message that indicates the name of the merchant, the amount of the purchase and the date of the purchase. In a department store transaction, the amount of the transaction is known when a point of sale terminal at the store receives data from the user's portable consumer device. Thus, in embodiments of the invention, the content in the intelligent alert message may vary depending on one or more of the following pieces of information in or information derived from an authorization request message or other data source. Such information may include or be derived from: an account number, the date, a transaction amount, and a merchant identifier (e.g., MCC, store number, merchant ID), or terminal ID.

Various tables of different specific messages or message templates may be associated with each of these data elements or combinations of data elements. For example, a message template under an MCC data element indicating a grocery store might be “You purchased $[insert purchased amount] of groceries on Jan. 4, 2009.” A message template under an MCC data element indicating a gas station might include “amount may vary” when an authorization request message is sent from the fuel dispenser, and might include “You purchased $[insert purchase amount] in gas at [insert merchant name] on [insert date] when the actual amount of the gas purchase is determined.”

Further, under the MCC data elements, the message templates can be further subdivided using other data elements such as the location of the transaction or the native language of the user. The location of the transaction can be determined using a merchant identifier and the native language of the user can be determined using the account number of the portable consumer device (i.e., by checking for the address associated with the account number). For instance, in the prior example, grocery store message templates can be further subdivided based upon the language of the cardholder.

The intelligent alert messages are generated in a format that can be received and viewed by each of the user devices that the user 110 has designated for receiving the alert messages. These user devices may be in the form of mobile device 200 or the user computer 210. In some embodiments, the user device and a user's portable consumer device may be one in the same (e.g., when a phone is used as both a communication device and also as a payment device). The notification server computer 171 refers to the cardholder enrollment data 175 to determine the user preferences with regard to one or more delivery channels specified by the user. For example, the notification server computer 171 determines the type of the mobile device 200 associated with the user 110 to determine the appropriate format of the alert message. The alert message sent to a mobile device 200 may have to be in a particular format and may conform to some requirements defined by the mobile device carriers 190. For example, a carrier may specify that a text message has a limit of characters, or that a size of a text message may not be more than a pre-determined number of bytes.

The notification server computer 171 may also access some other resources (not shown) to further enhance the intelligent alert messages. These resources may be in the form of translation tables or reference tables for abbreviations and symbols. Such resources may be part of the database 173, be stored in notification server computer 171, or be stored in a remote location. In some embodiments, the intelligent alert messages are translated into a language spoken by the user 110. During the enrolment process, the user 110 may be provided with the option of receiving the intelligent alert messages in his native language.

After accessing the alert customization data and determining the technical requirements and user preferences, the notification server computer 171 generates an intelligent alert message (step 306). This intelligent alert message generation is performed by a processor using a software application stored in the CRM 172 that is running on the notification server computer 171. The combination of such a software application and the notification server computer 171 can be referred to (in some cases) as an “intelligent rule engine” or an “intelligent notification engine.” In one embodiment, there may be more than one software application running on the notification server computer 171 and working in concert to access various resources such as database 173 to generate the intelligent alert messages. In another embodiment, some functions may be performed by an Application Specific Integrated Circuit (ASIC) that may be part of the notification server computer 171. In some other embodiments, the intelligent alert messages may be generated by the combination of software applications and ASICs.

In one embodiment, an intelligent alert message may be in a short format notifying the user 110 about a recent transaction. For example, if the user 110 uses the consumer portable device 120 to buy groceries, the alert message may state “The card was used for the purchase of groceries.” In other embodiments, an intelligent alert message may be enhanced with additional information such as name of the merchant, location of the merchant and the amount of the transaction. For example, if the user 110 used the portable consumer device 120 for purchasing $45.00 fuel at a Shell™ gas station at 123 First Street in San Francisco, the message may state “The card was used to purchase fuel at the Shell™ gas station in 123 First Street in San Francisco in the amount of $45.00.”

The determining factor in formatting and complexity of an intelligent alert message may be the combination of user preferences, technical requirements regarding the delivery channels, issuer preferences, and availability of data regarding the transaction. The notification server computer 171 considers such criteria when generating an intelligent alert message.

Some transactions involve a two-phase process. For example, when the user 110 purchases fuel at a gas station, the issuer 160 of portable consumer device 120 does not know the final amount of the transaction. Therefore, during a first phase, a pre-authorization request is sent by merchant 130 for an arbitrary amount to determine if the portable consumer device 120 is associated with an active and valid account number. This pre-authorization request is tagged with an identifier at PPN 150 before being transferred to the issuer 160. After the issuer 160 approves the transaction, the merchant 130 allows the user 110 to pump gas. In a second phase, when the merchant 130 determines the final amount of the transaction, an authorization request is sent to the issuer 160 from the PPN 150. The PPN 150 uses the identifier assigned to the pre-authorization request in the first phase to associate the two transactions with each other.

In two-phase transactions, the notification server computer 171 does not have enough information regarding the final amount. In one embodiment, the notification server computer 171 generates an intelligent alert message based on the transaction data related to the first phase pre-authorization data. The intelligent alert message may state “The card was used to purchase fuel. Amount may vary.” The notification server computer 171 may also suppress certain information related to the first phase of a transaction in a first message, and may enhance an intelligent alert message for the second phase when the transaction is finalized. User 110 may also be provided with the ability to choose whether he wants to receive intelligent alert messages related pre-authorization or not, during the enrollment process.

In some embodiments, the notification server computer 171 may replace the name of the actual merchant with a name of another merchant even if the user 110 can recognize the name of the actual merchant. For example, if the user 110 purchases airline tickets from a travel agency, the notification server computer 171 may replace the name of the travel agency with the name of the airline. In some other embodiments, the notification server computer may include a name of a second merchant in addition to the name of the first merchant. For example, an intelligent alert message may state “Your card was used to purchase an airline ticket from the United™ Airlines at www.Travelocity.com for the amount of $600.00.”

The notification server computer 171 may also strip data that may not be understood by the user 110. Usually, transaction data contain codes and symbols that contain processing information not usable by the user 110. Therefore, there is no need for the notification server 171 to translate these codes and symbol into a format that is understandable by the user 110.

In some embodiments, the location of user 110 may also be a determining factor regarding the format and the information that are included in an intelligent alert message. For example, if the user 110 purchases goods or services in a foreign country, the notification server computer 171 includes the currency in the intelligent alert message in both the transacting country currency (merchant country) and the consumer home country (issuer country). This may help the user 110 to easily recognize the transaction amount and realize the corresponding amount in the user country based on the current exchange rate.

The notification server computer 171 may compare the location of the merchant 130 with the location of the issuer 160 to determine if additional information regarding foreign currency should be included in the intelligent alert message.

In some embodiments, the intelligent alert messages may contain dynamic data provided by the issuer 160. These dynamic data are stored in the database 173 in the form of issuer data 176. Issuer data 176 contains other issuer information such as issuer criteria that may govern the generation and delivery of the intelligent alert messages. The dynamic data may be in the form of a logo of the issuer 160, or a logo of the type of the account of a user such as a premium account or a platinum account. These data are dynamic because the issuer 160 can replace them at any time with different formats or designs without interrupting the process of generating an intelligent alert message.

Using a logo of the issuer 160, the notification server computer 171 generates an intelligent alert message that can be easily recognized by user 110 as to what portable consumer device 120 is associated with a transaction. This is especially useful when user 110 receives intelligent alert messages for more than one portable consumer device 120 associated with different account numbers or different issuers.

In situations where the intelligent notification engine 171 generates more than one intelligent alert message for a transaction based on the preference of more than one delivery channels, each message may be customized based on criteria and requirements of each of the delivery channels. For example, if one intelligent alert message is being sent to the mobile device 200 in the form of a text message, and another one to the user computer 210 in the form of an e-mail, the notification server computer 171 may include more graphics and data in the e-mail message. In some embodiments, issuer 160 may have different logo formats for use with different delivery channels.

### D. Delivering the Intelligent Alert Message

When an intelligent alert message is generated by the notification server computer 171, it is sent to the delivery channel logic 177 for delivery to the user 110 (step 307). See also arrows 6b in FIG. 1. The delivery channel logic 177 may be in the form of one or more software applications running on one or more computers that are tasked with delivery of the intelligent alert messages to the appropriate delivery channel. In one embodiment, the delivery channel logic may be part of the IP gateway 170. In another embodiment, the delivery channel logic 177 may be a third party entity that receives the intelligent alert message via network connection 154 and sends it to an appropriate user device.

In one embodiment, the intelligent alert message may be sent along with an identifier that specifies what form of delivery channel should be used for the delivery of the message. Delivery channel logic 177 is in communication with mobile device carriers 190 and e-mail servers 180, for sending the intelligent alert messages in formats that are readable by the mobile device 200, and in the form of e-mail messages that are readable by user computer 210.

In some embodiments, an intelligent alert message may be sent to a user in the form of Interactive Voice Response (IVR), Instant Message (IM), Voicemail, etc. Therefore, FIG. 2 shows that delivery channel logic 177 is in communication with other delivery channels 178 that can deliver the intelligent alert messages in a variety of formats to a user device.

In some embodiments, the delivery channel logic 177 or the notification server computer 171 may cause the mobile device 200 to play an special audio file with a sound of a “beep” when receiving an intelligent alert message. In embodiments where the mobile device 200 and the portable consumer device 120 are incorporated into one physical device where user 110 can make a purchase by placing the mobile device 200 in the vicinity of an access device 132 having a wireless transmitter reader, the mobile device 200 plays a “beep” sound when the data from a computer-readable medium in the mobile device 200 are transmitted wirelessly to the access device 132. Shortly after, an intelligent alert message is generated and sent to the mobile device 200 where it makes a second “beep”, verifying that the transaction has gone through.

It can be appreciated that the intelligent alert messaging system 100 will provide numerous benefits for both the users and issuers. This system may advantageously be used as a security measure to reduce the occurrence of fraudulent transactions. For example, if a transaction is performed without the knowledge of the user 110, user 110 will immediately recognize that an intelligent alert message that was recently delivered to the mobile device 200 is not valid. The user 110 can immediately contact the issuer 160 and suspend the account that was fraudulently used to perform a transaction. This can benefit both the user 110 by the provision of a way of a messaging service that can be used to recognize fraudulent transactions, and the issuer 160 by preventing loss of revenue resulting from fraudulent transactions.

In addition, an intelligent alert message helps the user 110 to reduce the confusion that may arise as a result of the limited ability of the user 110 to interpret codes and symbols associated with transaction data 174. This may reduce the number of incorrect disputes by the user 110 for transactions that are valid but may not be recognized by the user 110. Moreover, this system may generate revenue by placing advertisements in the intelligent alert messages that are sent to the users 110.

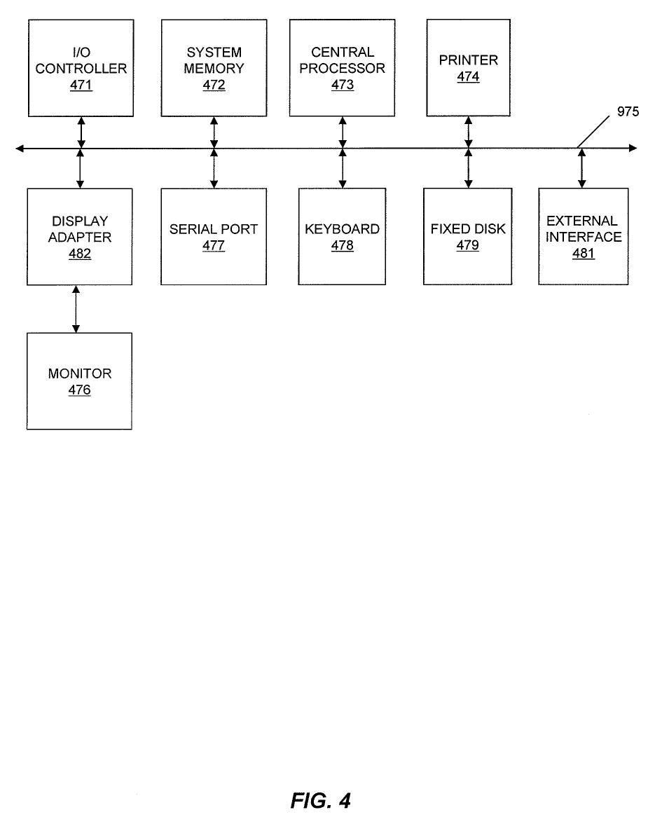

The various participants and elements in the previously described system diagrams (e.g., the computers, issuers, servers, etc. in FIGS. 1 and 2) may use any suitable number of subsystems to facilitate the functions described herein. Examples of such subsystems or components are shown in FIG. 4. The subsystems shown in FIG. 4 are interconnected via a system bus 475. Additional subsystems such as a printer 474, keyboard 478, fixed disk 479 (or other memory comprising computer-readable media), monitor 476, which is coupled to display adapter 482, and others are shown. Peripherals and input/output (I/O) devices, which couple to I/O controller 471, can be connected to the computer system by any number of means known in the art, such as serial port 477. For example, serial port 477 or external interface 481 can be used to connect the computer apparatus to a wide area network such as the Internet, a mouse input device, or a scanner. The interconnection via system bus allows the central processor 473 to communicate with each subsystem and to control the execution of instructions from system memory 472 or the fixed disk 479, as well as the exchange of information between subsystems. The system memory 472 and/or the fixed disk 479 may embody a computer-readable medium.

The software components or functions described in this application may be implemented as software code to be executed by one or more processors using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

The present invention can be implemented in the form of control logic in software or hardware or a combination of both. The control logic may be stored in an information storage medium as a plurality of instructions adapted to direct an information processing device to perform a set of steps disclosed in embodiments of the present invention. Based on the disclosure and teachings provided herein, a person of ordinary skill in the art will appreciate other ways and/or methods to implement the present invention.

In embodiments, any of the entities described herein may be embodied by a computer that performs any or all of the functions and steps disclosed.

Any recitation of “a”, “an” or “the” is intended to mean “one or more” unless specifically indicated to the contrary.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. An intelligent messaging system comprising:
a database comprising alert customization data; and
a notification server computer coupled to the database, wherein the notification server computer comprises a processor and a computer-readable medium coupled to the processor, the computer-readable medium comprising code executable by the processor for implementing a method comprising:
receiving transaction data for a transaction;
accessing the database comprising alert customization data;
generating an intelligent alert message using the transaction data using a notification server computer, and the alert customization data; and
sending the intelligent alert message to a user device.

2. The system of claim 1, wherein the intelligent messaging system is coupled to a payment processing network having an enrollment database that contains a list of account numbers that are enrolled in the messaging service.

3. The system of claim 2, wherein when an authorization request is received by the payment processing network for the account number enrolled in the messaging service, and the transaction data is sent to the notification server computer.

4. The system of claim 1, wherein a user can access the database and provide user data and setup a plurality of preferences.

5. The system of claim 1, wherein generating the intelligent alert message comprises using a merchant identifier in the transaction data to determine an intelligent message template that is used to generate the intelligent alert message.

6. The system of claim 1, wherein the message includes information related to a recent transaction.

7. The system of claim 1, wherein the notification server computer is further configured to dynamically place a plurality of issuer data in the message, and wherein the plurality of issuer data are setup by a plurality of issuers in the database.

8. A method comprising:
receiving transaction data for a transaction;
accessing a database comprising alert customization data;
generating an intelligent alert message using the transaction data using a notification server computer, a transaction type, and the alert customization data; and
sending the intelligent alert message to a user device.

9. The method of claim 8, wherein the alert customization data causes the alert message to make sense to a user with limited interpretation or confusion.

10. The method of claim 8, further comprising:
dynamically placing a plurality of issuer data in the intelligent alert message, wherein the plurality of issuer data are setup by a plurality of issuers in the database.

11. The method of claim 8, wherein receiving the transaction data for a transaction, accessing the database, generating the intelligent alert messages, and sending the intelligent alert message to the user are performed by a one or more software applications stored in a one or more computer-readable medium housed in the notification server computer.

12. The method of claim 8, wherein generating an intelligent alert message is performed based on determining a type of a user device.

13. The method of claim 8 wherein generating the intelligent alert message comprises using a merchant identifier in the transaction data to determine an intelligent message template that is used to generate the intelligent alert message.

14. A method comprising:
performing a transaction associated with an account number of a user; and
receiving an intelligent alert message at a user device,
wherein the intelligent alert message was generated by a notification server computer coupled to a database.

15. The method of claim 13, wherein the user sets a plurality of references regarding receiving the intelligent alert messages at a plurality of user devices during an enrollment process.

16. The method of claim 13, wherein the user receives an intelligent alert message containing dynamic data provided by an issuer associated with the account number.

17. The method of claim 13, wherein the intelligent alert message can be easily interpreted by the user.

18. The method of claim 14 wherein the intelligent alert message was generated using a merchant identifier in the transaction data and an intelligent message template.
